(19) United States
(12) Patent Application Publication
(10) Pub. No.: US 2007/0251151 A1
(43) Pub. Date: Nov. 1, 2007

(54) Splash guard device

(76) Inventor: Peter V. Janssen, Naples, FL (US)

Correspondence Address: EDWARD M. LIVINGSTON, PA, 963 TRAIL TERRACE DRIVE, NAPLES, FL, 34103, US

(21) Appl. No.: 11/411,520

(22) Filed: Apr. 26, 2006

(51) Int. Cl. E06B 11/00

(52) U.S. Cl. 49/381; 49/400

(57) ABSTRACT

A splash guard device (1) having a framework (9) with a top edge (17), a bottom edge (18) and two side edges (19) that protects a portion of a screened-in area (2) from water, dirt and debris. The splash guard device (1) is preferably affixed along the top edge (17) to a screened-in area (2) such that the splash guard device (1) may be opened and closed in an upward and downward motion. The framework (9) preferably surrounds at least one see-through section (7) so as to give a more aesthetically-pleasing appearance.

### BACKGROUND OF THE INVENTION

This invention relates to patio enclosures, more particularly, a splash guard device for use on patios, porches and lanais that is attractive and minimizes the amount of water, dirt and debris that enters the patio, porch or lanai.

Screened-in patios, porches and lanais are popular features of a house or apartment as they provide an area for individuals to experience the outdoors while being protected from undesired outdoor elements, such as bugs and insects. In addition, as the screened-in areas are typically covered with a roofing material, individuals are also protected from the rain and/or the direct rays of an overhead sun.

Although the apertures in the screen material permit wind to enter the area, which creates a sense of being outdoors, the apertures also permit other elements to enter as well, thereby making the area difficult to keep clean. For instance, rain, wind and other forces, such as leaf blowers and lawn mowers, oftentimes push dirt and debris into the screened-in area through the base of the screen enclosure. In addition, because door jams are usually located in the door opening of screened-in patios, porches and lanais, it is difficult to sweep out the area as the door jam creates a dam-like structure which catches dirt, rather than allowing it to pass through the doorway.

Furthermore, during thunderstorms and other inclement weather having wind and rain, rain may enter the screened-in area as the wind causes the rain to enter the area at an angle, thereby penetrating the screen, wetting the floor of the screened-in area and creating slippery conditions.

Although many people place boards, lattice or sheets of plastic along the base of the screen enclosure in order to minimize the amount of dirt and water that enters the screened-in area, there are several drawbacks to using such devices. First, these additions are unattractive from both the inside and outside of the screened-in area as they typically draw attention to the fact that a portion of the screen is obstructed. In addition, as the obstructive devices block one side of the screened-in area and are fixedly attached to a post adjacent to the screened-in area, a person may not hose off that portion of the screen for cleaning purposes as it is blocked on one side.

Thus, a need exists for a splash guard device that is that is attractive and minimizes the amount of water, dirt and debris that enters the patio, porch or lanai.

The relevant prior art includes the following references:

| Patent No. | | |
|---|---|---|
| (U.S. unless stated otherwise) | Inventor | Issue/Publication Date |
| 6,003,279 | Schneider | Dec. 21, 1999 |
| 4,909,004 | Panttila | Mar. 20, 1990 |
| 3,004,592 | Norton | Oct. 17, 1961 |
| 1,371,524 | Smith, Jr. | Mar. 15, 1921 |
| 6,668,495 | Prince | Dec. 30, 2003 |
| 6,755,004 | Power, Jr. et al. | Jun. 29, 2004 |
| 5,007,215 | Minter | Apr. 16, 1991 |
| 4,561,227 | Austin | Dec. 31, 1985 |
| 5,134,813 | Betts | Aug. 04, 1992 |
| 2005/0072538 | Hoffman | Apr. 07, 2005 |
| 6,915,833 | Hoffman | Jul. 12, 2005 |

### SUMMARY OF THE INVENTION

The primary object of the present invention is to provide a splash guard device that minimizes the amount of debris that enters a patio, porch or lanai.

A further object of the present invention is to provide a splash guard device that minimizes the amount of water that enters a patio, porch or lanai.

An even further object of the present invention is to provide a splash guard device that is attractive.

Another object of the present invention is to provide a splash guard device that may be opened and closed.

The present invention fulfills the above and other objects by providing a splash guard device that is affixed to a base portion of a screened-in area such that the splash guard device may be opened and closed. The splash guard device includes a framework having a top edge, a bottom edge and two side edges and is preferably affixed along the top edge so as to permit an upward opening of the splash guard. In the alternative, the framework may be affixed along a side edge so as to permit opening of the splash guard in a manner similar to a conventional door. The framework preferably surrounds at least one see-through section so as to give a more aesthetically-pleasing appearance.

The framework may also include a knob or handle for ease of use. In addition, the splash guard device may include a locking mechanism so as to lock the splash guard device in a closed position.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of a splash guard device of the present invention installed on a screened-in area;

FIG. 2 is a close-up partial frontal view of FIG. 1 showing the splash guard device;

FIG. 3 is a perspective view of the splash guard device of the present invention while being opened;

FIG. 4 is a side view of the splash guard device of the present invention;

FIG. 5 is a rear view of the splash guard device of the present invention; and

FIG. 6 is a frontal view of a second embodiment of the splash guard device of the present invention.

### DESCRIPTION OF THE PREFERRED EMBODIMENTS

For purposes of describing the preferred embodiment, the terminology used in reference to the numbered components in the drawings is as follows:
1. splash guard device, generally
2. screened-in area
3. screen
4. door
5. post
6. hinge
7. see-through section
8. knob
9. framework
10. arm
11. exterior wall
12. interior wall
13. cushion
14. locking mechanism
15. bolt
16. handle
17. top edge
18. bottom edge
19. side edge
20. planar surface

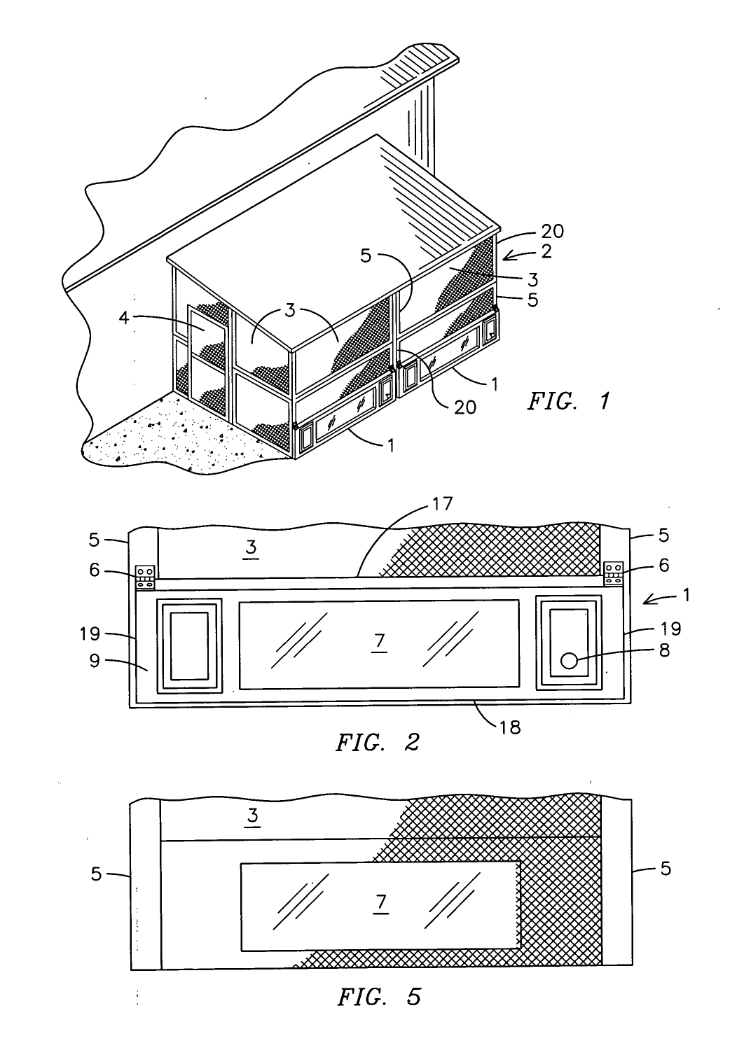

With reference to FIG. 1, a perspective view of a splash guard device of the present invention installed on a screened-in area is shown. The screened-in area 2 includes a plurality of planar surfaces 20, in this case posts 5 which are usually metal, having screens 3 attached thereto and in between the posts 5. The splash guard device 1 is preferably located along a base of a screened-in area 2, such as a patio, porch or lanai which may include a door 4, and is secured to the posts 5.

Next, FIG. 2 shows a close-up frontal view of the embodiment of FIG. 1. The splash guard device 1 is secured to the posts 5 via a fastening means, such as hinges 6, so as to permit a person to open and close the splash guard device 1. The splash guard device 1 includes a framework 9 having a top edge 17, a bottom edge 18 and two side edges 19. which is attached to the posts 5 and preferably includes at least one see-through section 7 which is preferably centrally located within the framework 9. The see-through section 7 may be transparent, tinted, colored, opaque, translucent or of varying colors and degrees of transparency. In addition, although the see-through section 7 is preferably made of a plastic material, the see-through section 7 may also be made of glass or other materials.

In addition, although a see-through section 7 is shown, the splash guard device 1 may be of a totally solid framework 9. A knob 8 may also be located on the framework 9 so as to permit easy opening and closing of the splash guard device 1.

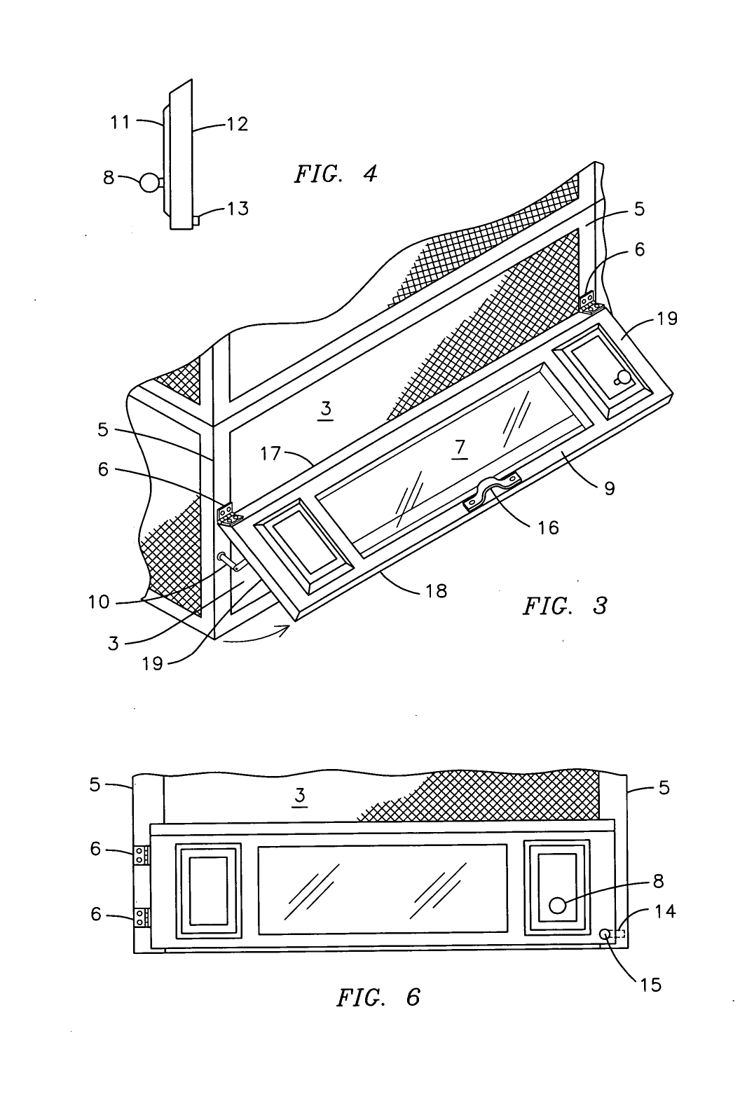

In FIG. 3, a perspective view of the splash guard device of the present invention while being opened is shown. When the hinges 6 are located along the top edge 17 of the framework 9, the splash guard device 1 is opened by pulling a knob or handle 16 in an upward direction so as to expose the screen 3. At least one optional arm 10 may be attached to the splash guard device 1 so as to lock the splash guard device 1 in an open position. When the arm 10 is in a fully extended position, the splash guard device 1 is completely open and locked in place. Other mechanisms for retaining the splash guard device 1 in varying degrees of a predetermined position may also be utilized.

FIG. 4 shows a side view of the splash guard device of the present invention. The splash guard device 1 has an exterior wall 11 and an interior wall 12 wherein the exterior wall 11 is exposed to the environment when installed on a screened-in area 2 while the interior wall 12 is adjacent to the screen 3. A cushion 13 may be secured at a predetermined position on the interior wall 12 so as to prevent the splash guard device 1 from rubbing against the screened-in area 2.

Next, a rear view of the splash guard device of the present invention is shown in FIG. 5. Because the splash guard device 1 is preferably secured externally to the screened-in area 2, a person may open the splash guard device 1 and spray the screen 3 from inside the screened-in area 2 to clean the screen 3.

Finally, FIG. 6 is a frontal view of a second embodiment of the splash guard device of the present invention. The second embodiment may include hinges 6 located along the side edge 19 of the screen guard device 1 so as to permit a person to open the screen guard device 1 in a manner similar to a conventional door. In addition, an optional locking mechanism 14 may be located at a predetermined location on the splash guard device 1 so as to prevent opening and closing of the splash guard device 1. The locking mechanism 14 preferably includes a bolt 15 which is insertable into a post 5 of the screened-in area 2.

Although the splash guard device 1 is preferably secured to at least one post 5 of a screened-in area 2, the splash guard device 1 may also be secured to building walls of both screened-in areas 2 and non-screened-in areas. Thus, although a post 5 is described and depicted as the object to which the splash guard device 1 is secured thereto, the splash guard device 1 is attachable to any other planar surface 20, including walls, window frames, etc.

The use of the present invention will provide an attractive device that minimizes the amount of water, dirt and debris that enters a patio, porch or lanai.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A splash guard device for an enclosure comprising:
a framework having a top edge, a bottom edge and at least two side edges;
said framework having an interior wall and an exterior wall;
at least one means for fastening said framework to at least one post of the enclosure; and
wherein said framework is fastened to said at least one post so as to permit opening and closing of the framework.

2. The splash guard device of claim 1 wherein:
said at least one means for fastening is via a hinge.

3. The splash guard device of claim 2 wherein:
said at least one hinge is located on said framework top edge.

4. The splash guard device of claim 2 wherein:
said at least one hinge is located on one of said at least two framework side edges.

5. The splash guard device of claim 1 further comprising:
a transparent portion located in said framework.

6. The splash guard device of claim 3 further comprising:
a transparent portion located in said framework.

7. The splash guard device of claim 1 further comprising:
at least one knob located on said framework.

8. The splash guard device of claim 6 further comprising:
at least one knob located on said framework.

9. The splash guard device of claim 1 further comprising:
at least one handle located on said framework.

10. The splash guard device of claim 1 further comprising:
at least one locking mechanism located on said framework.

11. The splash guard device of claim 8 further comprising:
at least one locking mechanism located on said framework.

12. The splash guard device of claim 10 wherein:
said locking mechanism includes a bolt insertable into said at least one post.

13. The splash guard device of claims 11 wherein:
said locking mechanism includes a bolt insertable into said at least one post.

14. The splash guard device of claim 1 further comprising:
at least one cushion located on said interior wall of said framework.

15. The splash guard device of claim 1 further comprising:
at least one arm secured to said interior wall of said framework and said at least one post.

16. The splash guard device of claim 3 further comprising:
at least one arm secured to said interior wall of said framework and said at least one post.

17. The splash guard device of claim 6 further comprising:
at least one arm secured to said interior wall of said framework and said at least one post.

18. A splash guard device comprising:
a framework having a top edge, a bottom edge and at least two side edges;
said framework having an interior wall and an exterior wall;
at least one means for fastening said framework to at least one post;
wherein said framework is fastened to said at least one post so as to permit opening and closing of the framework;
said at least one means for fastening is via a hinge;
said at least one hinge is located on said framework top edge;
a transparent portion located in said framework;
at least one knob located on said framework;
at least one locking mechanism located on said framework;
at least one cushion located on said interior wall of said framework;
at least one arm secured to said interior wall of said framework and said at least one post; and
said post is part of a screened-in area.

19. A splash guard device comprising:
a framework having a top edge, a bottom edge and at least two side edges;
said framework having an interior wall and an exterior wall;
at least one means for fastening said framework to at least one post;
wherein said framework is fastened to said at least one post so as to permit opening and closing of the framework;
said at least one means for fastening is via a hinge;
said at least one hinge is located on said framework top edge;
a transparent portion located in said framework;
at least one knob located on said framework;
at least one locking mechanism located on said framework;
at least one cushion located on said interior wall of said framework; and
at least one arm secured to said interior wall of said framework and said at least one post.
